(19) United States
(12) Patent Application Publication
(10) Pub. No.: US 2007/0074152 A1
(43) Pub. Date: Mar. 29, 2007

(54) Design Verification Using Efficient Theorem Proving

(76) Inventor: Kenneth Roe, Emerald Hills, CA (US)

Correspondence Address: PILLSBURY WINTHROP SHAW PITTMAN LLP, P.O. BOX 10500, MCLEAN, VA, 22102, US

(21) Appl. No.: 11/423,128

(22) Filed: Jun. 8, 2006

Related U.S. Application Data
(60) Provisional application No. 60/689,400, filed on Jun. 9, 2005.
(60) Provisional application No. 60/739,389, filed on Nov. 23, 2005.
(60) Provisional application No. 60/758,632, filed on Jan. 13, 2006.
(60) Provisional application No. 60/745,172, filed on Apr. 19, 2006.

(51) Int. Cl. G06F 9/44

(52) U.S. Cl. 717/104

(57) ABSTRACT

A heuristic theorem prover incrementally simplifies theorems so that they can be more efficiently solved. According to one aspect, the invention provides innovations in preprocessing theorems according to certain heuristics before they are processed using conventional DPLL(T) algorithms. In one innovation, a unate detection algorithm is used to efficiently locate case splitting. A second innovation includes using a scoring algorithm to decide case splits. This algorithm can either be used as an alternative to DPLL(T) algorithms or it can be used to choose some initial case splits before DPLL(T) processing is started. A third innovation includes the use of rewriting before the DPLL(T) solver is called. A fourth innovation introduces two encoding algorithms. The first removes domain theory predicates when there are only a small number of some subset of variables. The second is aimed at encoding difference logic as Boolean expressions.

### CROSS-REFERENCE TO RELATED APPLICATIONS

The present application is based on, and claims priority from, U.S. Prov. Appln. No. 60/689,400, filed Jun. 9, 2005, U.S. Prov. Appln. No. 60/739,389, filed Nov. 23, 2005, U.S. Prov. Appln. No. 60/758,632, filed Jan. 13, 2006, and U.S. Prov. Appln. No. 60/745,172, filed Apr. 19, 2006, the contents of each being incorporated herein by reference.

### FIELD OF THE INVENTION

The present invention relates to hardware or software design verification and scheduling and, more specifically, to design verification and scheduling using theorem proving.

### BACKGROUND OF THE INVENTION

Theorem provers have a wide range of applications such as library development, requirements analysis, hardware verification, fault-tolerant algorithms, distributed algorithms, semantic embeddings/backend support, real-time and hybrid systems, security and safety and compiler correctness. One type of theorem prover is known as a Satisfiability Modulo Theories (SMT) solver or prover. SMT provers have been considered for many uses such as chip design logic verification. In this hardware verification example, a front end program such as the Verilog parser in VIS, a synthesis/verification tool available from the University of California at Berkeley Center for Electronic Systems Design, can be used to extract the necessary theorems from either an RTL design description or a synthesizable behavioral description. Similar front ends could extract theorems necessary for software verification, or scheduling tasks.

One type of SMT theorem prover uses a so-called Davis-Putnam-Loveland-Logemann (DPLL(X)) approach, wherein a specialized solver Solver_{T} is considered, thus giving a DPLL(T) system. One example implementation of such a SMT solver is Barcelogic Tools from Universitat Politecnica de Catalunya. This solver can handle many theories such as those in the SMT problem library (i.e. SMT-LIB format) and the SMT Competition sponsored by the Computer Aided Verification conference.

In SMT and other provers or solvers, efficiency is an important goal, measured by, for example, the amount of time it takes to prove a theorem. While DPLL(T) approaches such as Barcelogic Tools provide adequate results, they exhibit certain inefficiencies for certain types of problems. Accordingly, additional efficiencies and robustness are needed.

### SUMMARY OF THE INVENTION

The present invention relates to systems and methods for incrementally simplifiying theorems so that they can be more efficiently solved. According to one aspect, the invention provides innovations in preprocessing theorems according to certain heuristics before they are processed using conventional DPLL(T) algorithms. In one innovation, a unate detection algorithm is used to efficiently locate case splits. A second innovation includes using a scoring algorithm to decide case splits. This algorithm can either be used as an alternative to DPLL(T) algorithms or it can be used to choose some initial case splits before DPLL(T) processing is started. A third innovation includes the use of rewriting before the DPLL(T) solver is called. A fourth innovation introduces two encoding algorithms. The first removes domain theory predicates when there are only a small number of some subset of variables. The second is aimed at encoding difference logic as Boolean expressions.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of one embodiment of a heuristic theorem prover according to the invention;

FIG. 2 is a block diagram of an example pre-processor that can be used in a theorem prover according to the invention;

FIG. 3 is a block diagram of an example solver that can be used in a theorem prover according to the invention;

FIG. 4 is a flow chart showing an example process of generating unate annotations according to an aspect of the invention.

FIGS. 5A and 5B are flowcharts of an example operation of a theorem prover according to the invention;

FIG. 6 is a block diagram of an alternative embodiment of a heuristic theorem prover according to the invention;

FIG. 7 is a flowchart illustrating a method of difference logic encoding that can be used in the alternative embodiment according to certain aspects of the invention;

FIG. 8 is a flowchart illustrating an example method of finding non-chordal cycles according to certain aspects of the invention;

FIG. 9 is a diagram illustrating an overall process of solving a theorem using a solver of the invention; and

FIG. 10 is a flowchart illustrating an example of the alternative embodiment of the invention involving the difference logic and small predicate encoders.

### DETAILED DESCRIPTION OF THE PREFERRED EMBODIMENTS

Embodiments of the present invention will now be described in detail with reference to the drawings, which are provided as illustrative examples so as to enable those skilled in the art to practice the invention. Notably, the figures and examples below are not meant to limit the scope of the present invention. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

In general, the invention provides a number of heuristic approaches to pre-process and/or partially solve a theorem before it is provided to conventional DPLL(T) algorithms. These heuristics greatly improve the efficiency of such algorithms.

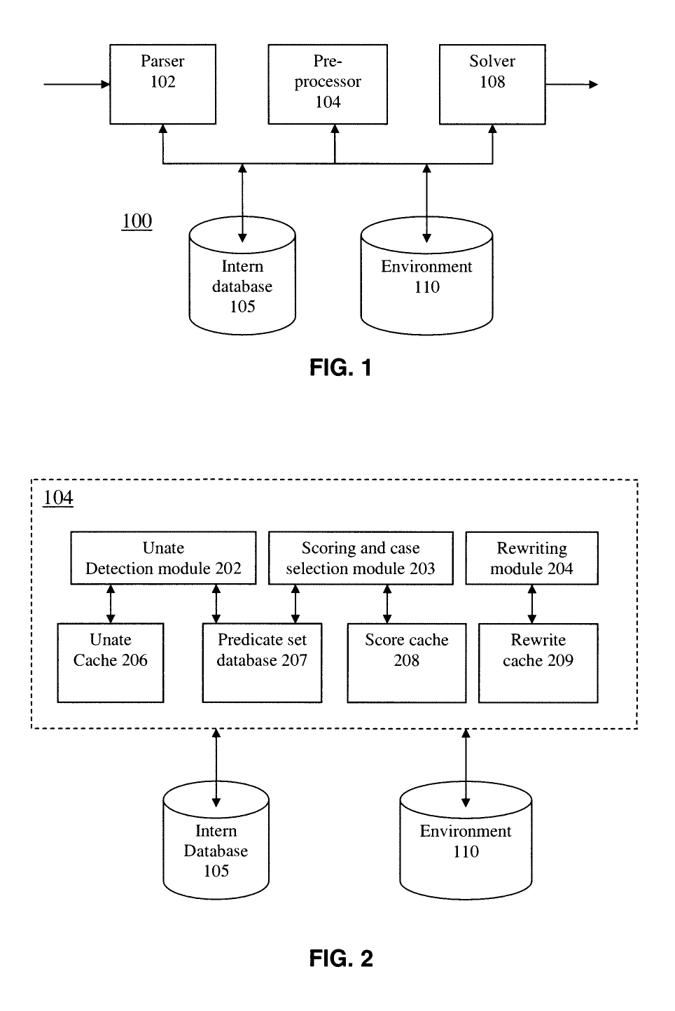

A block diagram illustrating an example heuristic theorem prover or solver 100 according to the invention is shown in FIG. 1. As shown in FIG. 1, prover 100 receives a theorem (e.g. in SMT-LIB format) which is first parsed into a form suitable for subsequent processing and stored in intern database 105 by parser 102. A pre-processor 104 simplifies and otherwise pre-processes and perhaps partially or completely solves the theorem. In some embodiments, the theorem is further processed by solver 108. Environment 110 stores state information needed by pre-processor 104 and/or solver 108 for recursively solving a theorem. Prover 100 can be implemented by one or more software programs executed by one or more computers within one or more operating and/or development environments.

It should be noted that the invention can be practiced with various combinations of the components illustrated in FIG. 1, including with fewer or additional components. Moreover, the ordering of components from left to right does not necessarily implicate a sequential order of processing. Rather, certain tasks within each component can be performed before, after, or simultaneously with certain tasks within other components, as will become more apparent from the teachings below. It should be further noted that prover or solver 100 can further include a main routine for managing the execution of tasks by pre-processor 104 and solver 108 as will become more apparent from the descriptions below.

Theorem prover 100 will be described in one example embodiment of this invention as being directed to solve a class of problems that Satisfiability Modulo Theories (SMT) theorem provers can solve (e.g. theorems in SMT-LIB format). However, the invention is not limited to being practiced with SMT theorem provers, but is applicable to other types of theorem provers and/or formats such as ACL2 from the University of Texas at Austin, PVS, VIS, Uclid, Ario, CVC Lite, Barcelogic Tools, Math-SAT, Simplics, Yices, CVC, ICS and Simplify, for example. Moreover, the input theorems are preferably extracted or parsed from a RTL hardware design using a tool such as VIS, but the invention is not limited to this application. Rather, the theorems can be abstracted from and/or characterize any type of problem currently or in the future contemplated for theorem proving such as library development, requirements analysis, hardware verification, fault-tolerant algorithms, distributed algorithms, semantic embeddings/backend support, real-time and hybrid systems, security and safety and compiler correctness. Those skilled in the art will be able to understand how to practice the invention using other theorem provers and/or formats, as well as for a variety of applications in addition to hardware verification, after being taught by the present disclosure.

The intern database 105 stores a received theorem in an internal representation. In one example embodiment, parser 102 translates all of the symbols of the expression (variable names, predicates and functions) into numbers as they are stored in the intern database 105. This increases the efficiency of a theorem prover because it is faster for modules to manipulate numbers rather than strings.

Intern database 105 preferably also stores all sub-expressions. Parser 102 can be viewed as translating the theorem into a large Directed Acyclic Graph (DAG) containing the subterms for the system. The intern database 105 is useful as other modules annotate the subterms with additional information, as discussed below. In one example, parser 102 also initializes a predicate set database that will be described in more detail below. Those skilled in the art will be able to understand how to implement a parser 102 in accordance with the particular format of the theorem (e.g. SMT-LIB) and the teachings of the invention as will be described in more detail below.

Environment 110 stores the set of predicates which have been asserted or denied. Whenever a new atomic predicate assertion/denial is proposed (as may be done during pre-processing or solving as will be described in more detail below), the environment 110 can be checked whether the new or asserted/denied predicates are consistent with the other predicates. For example, if the environment 110 has the predicate “x=y+1”, then adding “x=y+2” is inconsistent. There are known algorithms for domain solving, such as checking the consistency for linear equations and inequalities added, and these are preferably included in the invention, the details of certain of which are provided below. In addition, if a linear equation is added, it is automatically solved for one of its variables and a rewrite rule is added to eliminate all occurrences of that variable from the formula being proven. The linear algebra reasoning can be similar to that used in SVC, CVC, CVC lite, ICS and msat, and so is not explained in detail here. There are preferably also algorithms to deal with the theories of equality of uninterpreted function symbols and arrays with extensionality, as will be understood by those skilled in the art.

Environment 110 preferably includes a mark/release mechanism. This is used to restore the environment to the state it was in before a set of assertions was added. In addition to storing the raw set of asserted or denied predicates, environment 110 stores the data structures for use by modules in solver 108 as will be described in more detail below.

Also preferably stored in environment 110 is explanation information. At an abstract level, an explanation explains why two expressions are equivalent. For example, if the predicate “a=b+1” is asserted in the environment, then the expression “a+3” and “b+4” are equivalent. The explanation is the predicate “a=b+1”. For a negation, an expression is considered equivalent to “False”. For example, the expression “a=b+3” is equivalent to “False”. The explanation for this equivalency is again the one predicate “a=b+1”. Some equivalencies have empty explanations. For example the Boolean expression “a and b and True” is equivalent to “a and b”. This reduction is done by the rewriting module and is not dependent on any predicates in the environment. Hence its explanation is the empty set of predicates. This explanation information can be used by the solver 108 as will be explained in more detail below.

FIG. 2 illustrates an example pre-processor 104 according to certain aspects of the invention. As shown in FIG. 2, pre-processor 104 includes a unate detection module 202, a scoring and case selection module 203 and a rewriting module 204. These modules may be used to partially or fully solve the theorem. Alternatively, the simplified theorem can be further processed by solver 108, which can include a conventional DPLL(T) solver.

In general, the unate detection module 202 detects unate predicates for efficient rewriting. The scoring and case selection module 203 performs scoring to allow efficient case selection. The rewriting module 204 rewrites the original theorem. In this example, pre-processor 104 also includes a unate cache 206, a predicate set database 207, a score cache 208 and a rewrite cache 209 as will be described in more detail below.

The predicate set database 207 is a portion that stores the set of atomic predicates in the formula. A predicate is an expression that returns a Boolean value (true or false). An atomic predicate is a predicate in which no subterm is a predicate. The following theorem can be used as an example:
If x=y then not(x<y) else (x<y or y<x).
Here, x and y are real numbers.

For the expression above, there are three atomic predicates, x=y, x<y and y<x. The parser 102 initializes predicate set database 207 by assigning a unique integer identifier to each, starting with 0 for the first and incrementing by 1 for each subsequent predicate. As explained below, it is possible for the rewriting module 204 to introduce new atomic predicates. Thus, the predicate set database 207 can be modified dynamically.

In addition to storing the set of atomic predicates, the following two types of additional information about the atomic predicates can be initialized and stored in database 207 by parser 102

First, the predicate set database 207 stores the set of atomic predicates present in each subterm of the original theorem and for each subterm occurring in subsequent formulas generated from case splitting and rewriting.

Second, for any pair of atomic predicates, the predicate set database 207 stores information on how one impacts the other. For example, if either asserting or denying one of the predicates forces the other to be true or false, then that information is stored. In the above example, asserting “x=y” forces “x<y” to be false. In some cases, one predicate will cause another to reduce to a simpler form. For example, given the two predicates “x=y” and “x+y=z”, then the first will cause the second to reduce to “2x=z” (by eliminating y). When dealing with a linear equation, one variable can be arbitrarily selected for elimination.

TABLE 1 illustrates the information stored in predicate set database 207 for the three atomic predicates of the above example.

TABLE 1

| | | Dependency information | | | | | |
|---|---|---|---|---|---|---|---|
| | | x = y | | x < y | | y < x | |
| Number | Predicate | assert | Deny | assert | deny | assert | deny |
| 0 | x = y | True | False | False | x = y | False | x = y |
| 1 | x < y | False | x < y | True | False | False | x < y |
| 2 | y < x | False | y < x | False | y < x | True | y < x |

The first column contains the unique number assigned to each atomic predicate. The second column contains the predicate. The remaining columns show impact information. For example, if it is desired to know what happens with “x<y” when “x=y” is asserted, then the “x<y” row and the “x=y” column are examined and the assert sub-column. It can be seen that “x<y” becomes “False” in an environment in which “x=y” is True. Similarly, if “x=y” is False, then “x<y” is unchanged from the “deny” sub-column.

The predicate set database 207 preferably includes a mark/release mechanism. For example, there is a “mark” function that, when called, returns a handle that can be sent to a “release” function to remove all data added after “mark” was called. This is useful to remove data that was added in processing one branch of a theorem. Often, much of that data is no longer needed, or even if it is needed, it can be easily regenerated. The mark and release functions for predicate set database 207 are generally called at the same time as the mark and release functions of environment 110.

One example embodiment of unate detection module 202 will now be explained in more detail. A unate split involves a predicate where either asserting or denying it will cause the theorem to reduce to true. For example, in the expression
(a<b) and ((b=c) or (a+1=b))
if the predicate “a<b” is denied, this will make the entire expression false. Similarly if the predicate “a+1=b” is asserted, this will make the entire expression true.

In order to detect such unate case splits, the algorithm starts by identifying the atomic predicates and their dependencies. This information is stored in the predicate set database 207. In the above case, there are three atomic predicates, a<b, b=c and a+1=b. Also, there is a fact that a+1=b implies that a<b is true. This information is stored in the predicate database 207. There is also the converse as a dependency, if a<b is false, then a+1=b is also false.

In one example implementation of the invention, for each term in a Boolean expression, which is either an atomic predicate or non-atomic expression, the term is annotated with four sets that are represented as bit vectors. The first is the set of atomic predicates that when asserted make the whole expression true. The second is the set of atomic predicates that when asserted make the whole expression false. The third is the set of atomic predicates when denied make the whole expression true. The fourth is the set of atomic predicates that when denied make the whole expression false. For short, these sets are called “assert_makes_true”, “assert_makes_false”, “deny_makes_true”, and “deny_makes_false”.

To illustrate this unate set data, TABLE 2 shows an example of fully computed data for the terms a<b, b=c, (a+1=b) and (a<b) and ((b=c) or (a+1=b)) in the above illustrative expression (a<b) and ((b=c) or (a+1=b)).

TABLE 2

| | a < b | | | | b = c | | | | a + 1 = b | | | |
|---|---|---|---|---|---|---|---|---|---|---|---|---|
| | Assert | Deny | Assert | Deny | Assert | Deny | Assert | Deny | Assert | Deny | Assert | Deny |
| | Makes | Makes | Makes | Makes | Makes | Makes | Makes | Makes | Makes | Makes | Makes | Makes |
| Term | True | true | False | False | True | True | false | false | True | true | false | false |
| a < b | X | | | X | | | | | X | | | |
| b = c | | | | | X | | | X | | | | |
| a + 1 = b | | | | X | | | | | X | | | X |
| (b = c) or (a + 1) = b | | | | | X | | | | X | | | |
| (a < b) and | | | | X | | | | | X | | | |
| ((b = c) or | | | | | | | | | | | | |
| (a + 1 = b)) | | | | | | | | | | | | |

As an example of how to read the table, there is an “X” in the “Deny makes false” sub-column of “a<b” for the overall expression “(a<b) and ((b=c) or (a+1=b))”. This means that if the atomic predicate “a<b” is denied, then the latter expression is false. Similarly, there is an “X” in the “Assert Makes True” sub-column of “a+1=b”, which means that if the atomic predicate “a+1=b” is asserted, the overall expression is true. So the unate predicates for this example expression are “a<b” and “a+1=b”.

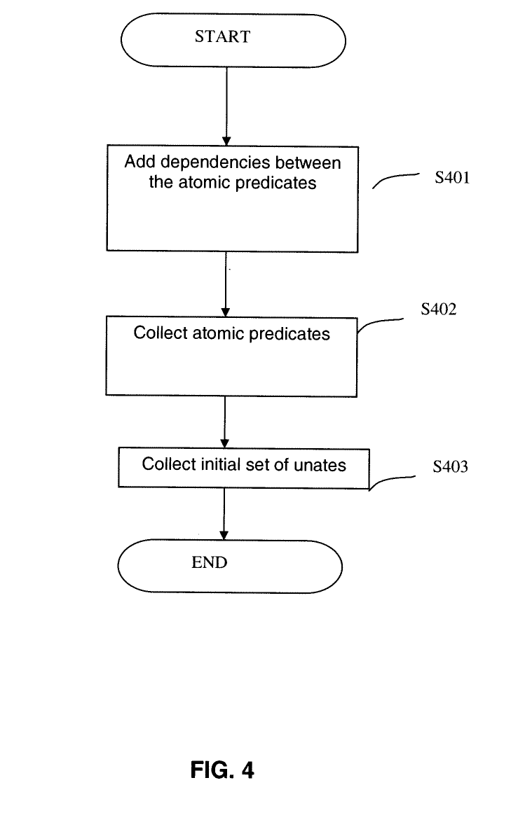

FIG. 4 illustrates an example process of identifying unate predicates in an expression. The process first adds dependency information between the atomic predicates (Step S401). So, in the above example, since a+1=b implies a<b, the process adds a+1=b to the assert_makes_true set for a<b. Also, since if a<b is false, a+1=b is false, and the process adds a<b to the deny_makes_false set for a+1=b.

As shown in FIG. 4, the process continues by annotating the atomic predicates (Step S402). The process adds the atomic predicate itself to its own “assert_makes_true” and “deny_makes_false” sets.

The process then collects an initial set of unates by combining information about the atomic predicates for the non-atomic expressions based on rules for annotation of compound Boolean expressions (Step S403). Consider the expression “(b=c) or (a+1=b)”. The assert_makes_true and deny_makes_false sets for this formula can be determined by taking the union of the assert_makes_true and deny_makes true sets of the two atomic predicates b=c and a+1=b. The assert_makes_false and deny_makes_false sets can be created by taking the intersection of the assert_makes_false and deny_makes_false sets of the two atomic predicates. In the above example expression, the assert_makes_true set contains two elements, “b=c” and “a+1=b”. The other three sets are empty. A similar propagation can be done to annotate over the “and” expression at the top of the formula. The result here is that the assert_makes_true set contains the single predicate “a+1=b”.

In a preferred implementation, the following rules for annotation of the compound Boolean expressions can be used to combine dependency information:
assert_makes_true_{A and B}=assert_makes_true_{A}∩ assert_makes_true_{B}
assert_makes_false_{A and B}=assert_makes_false_{A}∪assert_makes_false_{B}
deny_makes_true_{A and B}=deny_makes_true_{A} ∪deny_makes_true_{B}
deny_makes_false_{A and B}=deny_makes_false_{A}∩deny_makes_false_{B}
assert_makes_true_{A or B}=assert_makes_true_{A}∪assert_makes_true_{B}
assert_makes_false_{A or B}=assert_makes_false_{A}∩ assert_makes_false_{B}
deny_makes_true_{A or B}=deny_makes_true_{A}∩ deny_makes_true_{B}
deny_makes_false_{A or B}=deny_makes_false_{A}∪deny_makes_false_{B}
assert_makes_true_{not A}=assert_makes_false_{A}
assert_makes_false_{not A}=assert_makes_true_{A}
deny_makes_true_{not A}=deny_makes_false_{A}
deny_makes_false_{not A}=deny_makes_true_{A}

Note that combination rules are not limited to the operators in the above list. It is possible to create combination operators for other operators such as if-then-else and xor. Those skilled in the art will be able to arrive at combination operators for those and other operators after being taught by the present invention.

The process finally obtains the unates (Step S403). The unates are obtained as the set of atomic predicates in the “assert_makes_true” and “deny_makes_true” sets of the top level formula. As illustrated in the example of TABLE 2, the top level formula is the expression (a<b) and ((b=c) or (a+1=b)), and the identified unates are “a<b” and “a+1=b”.

The unate detection module 202 preferably caches the assert_makes_true, deny_makes_true, assert_makes_false and deny_makes_false sets for each term in a unate cache 206. The unate cache 206 helps decrease the amount of computation. For example, if a subterm appears more than once in the expression, then the computation of unates only needs to be done once.

One example embodiment of scoring and case selection module 203 will now be explained in more detail. The scoring and case selection can be independent from unate detection, and it is possible to use only one of them in a theorem prover. In this embodiment, modules 202 and 203 are both used in theorem prover 100, but the invention is not limited to this embodiment.

In this embodiment, if no unate predicate is detected by module 202, the scoring and case selection module 203 scores each predicate based on the amount of rewriting that is expected to be done when the predicate is asserted or denied. Consider the following theorem as an example:
if a=b then not(a<b) else (if a=c then (b<c or c<b) else (a<b or b<a))

This expression contains six atomic predicates, a=b, a<b, b>a, a=c, b<c, and c<b. The scoring and case selection module 203 creates a score for each of them based upon the amount of rewriting each is expected to produce.

There can be various rules for computing the score. In one embodiment, the following rules are used. First, the system adds 2 for each atomic predicate that is either removed, or reduced to true when asserted (i.e. “positive” score) or false when denied (i.e. “negative” score). Then 1 is added for each function (if/and/or/not) that is removed. Consider the assertion of “a=c”. The one occurrence of “a=c” is reduced to true, this gives a positive score of “2” for a=c. Moreover, this expression is contained in an “if-then-else,” which is eliminated when a=c is asserted. This adds “1” to the positive score of a=c. Also note that the subterm of the “else” portion is discarded. This eliminates two atomic predicates, “a<b” and “b<a” as well as the “or” function that combined them. This gives 5. Adding this to the scores from above gives a total positive score of 8 for asserting “a=c”.

The scoring algorithm preferably recursively descends the expression, computing scores for each node in the expression. Results for each node are cached in the score cache 208. The cache is persistent across successive case split evaluations. Typically, a single case split only replaces a few subterms of the parent theorem. Hence, a considerable amount of time is saved recomputing scores of terms. More specifically, the scoring cache 208 stores for each subterm and atomic predicate the following:
(1) The “positive” score for that term if the atomic predicate is asserted.
(2) The “negative” score for that term if the atomic predicate is denied.
(3) An approximation of what the expression will be after rewriting the subterm with the predicate asserted. Specifically, if the term reduces to “true”, “false” or any subterm of the original, then that is stored, otherwise the original subterm is stored.
(4) An approximation of what the expression will be after rewriting the subterm with the predicate denied similar to the above.

Also for each subterm, an “elimination score” is computed. This is the score represented by that subterm if some predicate causes it to be eliminated entirely from the expression. In the above example, the subterm “(a<b) or (b>a)” has an elimination score of 5. This is added in when computing the score for asserting “a=c”.

All of this information is needed to compute the score of a parent term after computations have been done for all its subterms.

TABLE 3 below shows one example of how scoring information is computed for each subterm. Note that if the box for “pos exp” (i.e. approximation of expression after rewriting due to assertion of subterm) or “neg exp” (i.e. approximation of expression after rewriting due to denial of subterm) is not filled in, this means that the expression is the same as the original.

TABLE 3

| | | a = b | | a = c | | a < b | |
|---|---|---|---|---|---|---|---|
| | | Pos | Neg | Pos | Neg | Pos | Neg |
| | | score | Score | score | score | Score | score |
| | Elim. | Pos | Neg | Pos | Neg | Pos | Neg |
| Term | Score | exp | Exp | exp | Exp | Exp | exp |
| a = b | 2 | 2 | 2 | 0 | 0 | 2 | 0 |
| | | true | false | | | false | |
| a = c | 2 | 0 | 0 | 2 | 2 | 0 | 0 |
| | | | | true | false | | |
| a < b | 2 | 2 | 0 | 0 | 0 | 2 | 2 |
| | | false | | | | true | false |
| b < a | 2 | 2 | 0 | 0 | 0 | 2 | 0 |
| | | false | | | | false | |
| b < c | 2 | 0 | 0 | 0 | 0 | 0 | 0 |
| c < b | 2 | 0 | 0 | 0 | 0 | 0 | 0 |
| not(a < b) | 3 | 3 | 0 | 0 | 0 | 3 | 3 |
| | | True | | | | False | True |
| (b < c) or | 5 | 0 | 0 | 0 | 0 | 0 | 0 |
| (c < b) | | | | | | | |
| (a < b) or | 5 | 0 | 0 | 0 | 0 | 5 | 3 |
| (b < a) | | | | | | True | B < a |
| if a = c | 13 | 0 | 0 | 8 | 8 | 5 | 3 |
| then (b < c) | | | | (b < c) | (a < b) | if a = c | if a = c |
| or (c < b) | | | | or | or | then (b < c) | then (b < c) |
| else (a < b) | | | | (c < b) | (b < a) | or (c < b) | or (c < b) |
| or (b < a) | | | | | | else true | else b < a |
| if a = b | 19 | 19 | 6 | 8 | 8 | 11 | 3 |
| then not(a < b) | | false | if a = c | if a = b | if a = b | if a = c | if a = b |
| else (if a = c | | | then (b < c | then not | then not | then (b < c) | then not |
| then (b < c or | | | or c < b) | (a < b) | (a < b) | or(c < b) | (a < b) |
| c < b) | | | else (a < b | else (b < c) | else (a < b) | else true | else (if a = c |
| else (a < b or | | | or b < a) | or (c < b) | or (b < a) | | then (b < c) |
| b < a)) | | | | | | | or (c < b) |
| | | | | | | | else b < a) |

| | | b < a | | b < c | | c < b | |
|---|---|---|---|---|---|---|---|
| | Elim. | Pos score | Neg score | Pos score | Neg score | Pos score | Neg Score |
| Term | Score | Pos exp | Neg exp | Pos exp | Neg exp | Pos exp | Neg exp |
| a = b | 2 | 2 | 0 | 0 | 0 | 0 | 0 |
| | | false | | | | | |
| a = c | 2 | 0 | 0 | 0 | 0 | 0 | 0 |
| a < b | 2 | 2 | 0 | 0 | 0 | 0 | 0 |
| | | false | | | | | |
| b < a | 2 | 2 | 2 | 0 | 0 | 0 | 0 |
| | | true | false | | | | |
| b < c | 2 | 0 | 0 | 2 | 2 | 2 | 0 |
| | | | | True | False | False | |
| c < b | 2 | 0 | 0 | 2 | 0 | 2 | 2 |
| | | | | False | | True | false |
| not(a < b) | 3 | 3 | 0 | 0 | 0 | 0 | 0 |
| | | True | | | | | |
| (b < c) or | 5 | 0 | 0 | 5 | 3 | 5 | 3 |
| (c < b) | | | | True | c < b | true | b < c |
| (a < b) or | 5 | 5 | 3 | 0 | 0 | 0 | 0 |
| (b < a) | | True | A < b | | | | |
| if a = c | 13 | 5 | 3 | 5 | 3 | 5 | 3 |
| then (b < c) | | if a = c | if a=c | if a = c | if a = c | if a = c | if a = c |
| or (c < b) | | then (b < c) | then (b < c) | then true | then c < b | then true | then b < c |
| else (a < b) | | or (c < b) | or (c < b) | else (a < b) | else (a < b) | else (a < b) | else (a < b) |
| or (b < a) | | else true | else a < b | or (b < a) | or (b < a) | or (b < a) | or (b < a) |
| if a = b | 19 | 11 | 3 | 5 | 3 | 5 | 3 |
| then not(a < b) | | if a = c | if a = b | if a = b | if a = b | if a = b | if a = b |
| else (if a = c | | then (b < c) | then not | then not | then not | then not | then not |
| then (b < c or | | or (c < b) | (a < b) else | (a < b) else | (a < b) | (a < b) | (a < b) |
| c < b) | | else true | (if a = c | (if a = c | else (if a = c | else (if a = c | else (if a = c |
| else (a < b or | | | then (b < c) | then true | then c < b | then true | then b < c |
| b < a)) | | | or (c < b) | else (a < b) | else (a < b) | else (a < b) | else (a < b) |
| | | | else a < b) | or (b < a)) | or (b < a)) | or (b < a)) | or (b < a)) |

One example embodiment of rewriting module 204 will now be described in more detail. In a preferred example, module 204 simplifies expressions with respect to the current set of asserted and denied predicates in environment 110, as such predicates are identified by unate detection module 202 and/or scoring and case selection module 203. The rewriting module can be similar to what exists in other systems such as SVC, and can further include or call similar functions for domain solving of rewritten formulas against environment 110, some of which will be described in more detail below. Algebraic equations are simplified using a number of standard simplification rules. Examples include:
(1) Distributing multiplication over addition.
(2) Collecting like terms.
(3) Whenever possible, a linear equality will be solved for one of its variables.

A number of Boolean simplification rules also exist. For example, the expression “a and false” will be reduced to “false”.

Contextual rewriting can be done under certain conditions. For example, within the context of “and”, if there is both “a=b” and “a<=b”, since the former implies the latter, the “a<=b” is eliminated. Moreover, if it is known from environment 110 that an atomic predicate is true or false, then the rewriting module can rewrite all occurrences of that expression in a formula to true or false.

The following TABLE 4 shows rewriting of some sample expressions.

TABLE 4

| Before rewriting | After Rewriting |
|---|---|
| if a + a = a + a + 2 then b = 3 else c = 4 | c = 4 |
| 1 + 1 + 1 + 1 + a | 4 + a |
| a + a + b = b + 2 | a = 1 |
| a and (if true then b else c) | a and b |
| a <= b and a == b | a == b |

The rewrite cache 209 stores the result of simplifying each subterm. If the same subterm is encountered more than once, the stored result is taken from the rewrite cache 209.

An example implementation of solver 108 according to one embodiment of the invention will now be described.

Generally, solver 108 can be a program such as a SAT solver that finds an assignment that satisfies a Boolean expression in conjunctive normal form. As an example, the following expression
(a or b) and (not(a) or not(b))
can be satisfied with the assignments “b=true, a=false”. However, the following Boolean expression:
(a or b) and (not(a) or not(b)) and (a or not(b)) and (not(a) or b)
cannot be satisfied. A SAT solver returns an answer indicating whether the input expression is satisfiable. There are many existing SAT solvers. zChaff is an example.

DPLL(T) is an extension to SAT solving techniques in which variables are replaced with predicates from a domain theory. For example, a DPLL solver may be used to solve an expression like:
(a<b or a>b+3) and a>b and a<b+2

Note that instead of having variables there are the predicates “a<b”. The DPLL(T) theorem prover or solver first abstracts this theorem with four predicate variables identified as P1, P2, P3 and P4 where P1=a<b, P2=a>b+3, P3=a>b and P4=a<b+2. This gives:
(P1 or P2) and P3 and P4

The SAT solver takes the above Boolean expression and produces a solution. One solution is “P1=True”, “P2=False”, “P3=true”, “P4=true”. The DPLL(T) solver then checks the solution against the domain theory (using tests as will be explained in more detail below). Note that, in the above example, P1 and P3 cannot both be true (i.e. it is impossible for “a>b” and “a<b”). So this solution is rejected. Similarly, the other solutions are rejected. The DPLL(T) solver concludes that this expression has no solution.

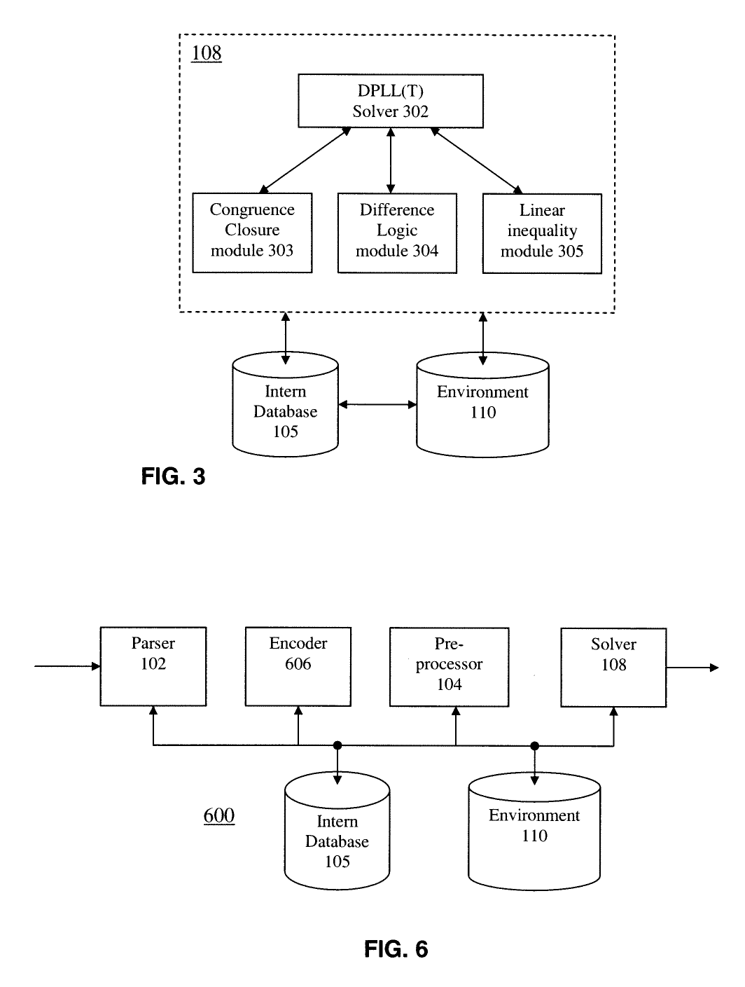

FIG. 3 illustrates a solver 108 according to one example embodiment. As shown in FIG. 3, solver 108 includes a DPLL(T) solver 302, congruence closure module 303, difference logic module 304, and linear inequality module 305. Modules 303, 304 and 305 use information from intern database 105 and store intermediate information which can be used to detect contradictions in environment 110.

An example implementation of DPLL(T) solver 302 is the BarcelogicTools SMT solver. This solver and other relevant algorithms are described in, for example, H. Ganzinger et al., “DPLL(T): Fast Decision Procedures,” 16th International Conference on Computer Aided Verification (CAV), July 2004, Boston, Mass.; R. Nieuwenhuis et al., “Abstract DPLL(T) and Abstract DPLL(T) Modulo Theories,” 11th International Conference for Programming, Artificial Intelligence and Reasoning (LPAR). March 2005, Montevideo Uruguay; R. Nieuwenhuis and A. Oliveras, “Proof-producing Congruence Closure,” 16th International Conference on Rewriting Techniques and Applications (RTA), April 2005, Nara Japan; R. Nieuwenhuis and A. Oliveras, “DPLL(T) with Exhaustive Theory Propagation and its Application to Difference Logic,” 17th International Conference on Computer Aided Verification (CAV), July 2005, Edinburgh Scotland; M. Moskewicz et al., “Chaff: Engineering an Efficient SAT Solver,” 39th Design Automation Conference (DAC 2001), Las Vegas, June 2001; and C. Barrett et al., “Validity Checking for Combinations of Theories with Equality,” FMCAD'96, November 1996.

In one preferred embodiment, DPLL(T) solver 302 is implemented as a parameterized SAT solver module in which different domain theories can be hooked in. For each domain theory, the following procedures are performed: (note that a signed predicate is either an atomic predicate P or the construction not(P) where P is an atomic predicate)
Bool Add_predicate(SignedPredicate P)

The above Add_predicate function causes the predicate P to be added to the environment, and checks its consistency with the environment. If “P” is inconsistent with predicates already in the environment then “true” is returned. Otherwise “false” is returned.
Set (SignedPredicate) propagate ( )

After a predicate is added, the above propagate function is called to return the set of predicates implied by the new predicate. Note that the predicate set database 207 contains the set of all known atomic predicates used in the system. The propagate function will return the set of signed atomic predicates that are implied by the current environment 110.
Set(SignedPredicate) explain(SignedPredicate P)

If the set of predicates in the environment 110 implies the truth assignment of P, the explain function can be used to return the subset of predicates that implied that truth value. For example, if the environment 110 contains “a<b”, “a<d”, “b<c” and “c<d” and P is the predicate “a<c”, then the explain function would return the two predicates “a<b” and “b<c” as these are the two predicates that imply “a<c”.
Int score(SignedPredicate P)

The score function returns a score indicating the likelihood that predicate P will cause further propagations. It is used by the DPLL(T) procedure to choose a predicate for assertion or denial. Note that a conventional DPLL(T) procedure simply counts occurrences of a predicate within its tuple data base. The scores obtained by this routine can be used to enhance the conventional DPLL(T) scoring.
Char *mark( )
Void release(char *)

These two functions can be used by the DPLL(T) solver to mark the current state of the environment (of domain theory assertions) and to restore back to a previously marked state.

Note that satisfiability is the converse of theorem proving. In essence, proving a theorem T is equivalent to using the satisfiability solver to show that not(T) is unsatisfiable. Hence, the satisfiability solver is actually used to prove the portion of a theorem in disjunctive normal form.

To test the theorem against a domain theory (i.e. perform domain solving), DPLL(T) solver 302 calls the congruence closure module 303, difference logic module 304 and linear inequality module 305, perhaps as well as linear algebra and other domain theory decision procedures.

Moreover, for each domain theory, the four procedures described above are needed for the DPLL(T) module. Description of preferred algorithms that can be used for these four procedures are found in the Barcelogic and SVC papers given as references above. These algorithms require some specialized data structures to implement the required methods for the DPLL(T) solver. These data structures are stored by environment 110 along with the set of asserted predicates, and an understanding of them can be gleaned by those skilled in the art based on the above references and the present teachings. The “mark/release” mechanism of the environment 110 module also marks and releases the specialized data structures used by the congruence closure 303 and difference logic 304 modules.

For any two subexpressions “e1” and “e2” that have ever been seen by the theorem prover, either as part of the original theorem or derived from subsequent simplifications, environment 110 preferably stores whether or not “e1” and “e2” are equivalent and if they are the “explanation” which is the set of predicates required to make them equivalent. In one example embodiment, the congruence closure 303 module contains the known SVC algorithm for quickly finding equivalent terms and a data structure for storing the equivalency information. The difference logic 304 module identifies new inequalities from the set of inequalities in the environment. For example, if the environment contains “a<b” and “b<c”, then the difference logic 304 module identifies “a<c” as being true. Within the explanation data structure, this information is encoded as the fact that “a<c” is equivalent to “True” and the explanation are the two predicates “a<b” and “b<c”. An efficient algorithm for storing the explanations for equivalent terms is included in the BarcelogicTools system and described in the above-referenced papers, and can be used in one example embodiment of the invention. A detailed paraphrase of this algorithm is quite complex, and not needed here for an understanding of the present invention. Instead, one is referred to R. Nieuwenhuis and A. Oliveras, “Proof-producing Congruence Closure,” 16th International Conference on Rewriting Techniques and Applications (RTA), April 2005, Nara Japan.

Linear inequality module 305 determines for a set of linear inequalities whether there is an assignment to the variables that satisfies all the inequalities. Known algorithms such as those described, for example in H. Russ and N. Shankar, “Solving Linear Arithmetic Constraints,” SRI-CSL Tech. Rep. CSL-SRI-04-01, Jan. 15, 2004, can be used to implement module 305.

It should be noted that domain solving functionality such as that included in modules 303, 304 and 305 can also be called whenever a formula is rewritten or when a predicate assertion/denial needs to be checked for consistency with environment 110.

An example operation of prover 100 will now be described. According to an aspect of the invention, prover 100 includes a main routine that recursively calls itself and calls tasks in solver 108 and/or pre-processor 104 multiple times to solve a theorem, wherein the functionalities of pre-processor 104 allows the theorem to be proved more efficiently than with just a conventional solver working alone.

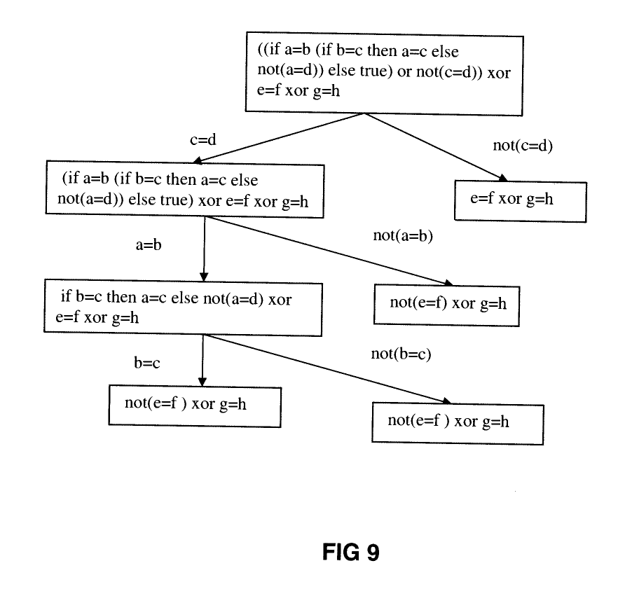

FIG. 9 is a top-level diagram showing how preprocessor 104 and solver 108 are called by a main routine to solve the example theorem “((if a=b (if b=c then a=c else not(a=d)) else true) or not(c=d)) xor e=f xor g=h”. In general, the main routine will use case-splifting and rewriting to simplify and solve the theorem until either any branch of the theorem reduces to, or is found by a DPLL(T) solver to be false (meaning the theorem cannot be satisfied), or all branches of the theorem reduce to, or are found to be true (meaning the theorem is satisfiable).

In this example of FIG. 9, “c=d” is chosen for splitting by the preprocessor 104 (e.g. unate detection 202 or scoring algorithm 203). For the false branch (i.e. deny c=d or assert not(c=d)), no further splitting is done. For example, after splitting, rewriting is performed using not(c=d), and a scoring algorithm is called in pre-processor 104 (e.g. because the pre-processor detects that the rewritten formula has no unates). If a scoring threshold value is 6 and the scoring algorithm of the pre-processor 104 determines that both of the remaining atomic predicates (e=f) and (g=h) have a score of 5, solver 108 would then be called by the main routine to finish this branch.

For the true branch (i.e. assert predicate c=d), after rewriting using this asserted predicate, another split (as determined by preprocessor 104) can be done with “a=b” and similarly for the true branch of this split, preprocessor 104 determines that a third split can be done on “b=c”. As a result, as shown in this example, solver 108 only needs to operate on four significantly simplified versions of the original theorem, which can greatly reduce the time needed to prove the theorem.

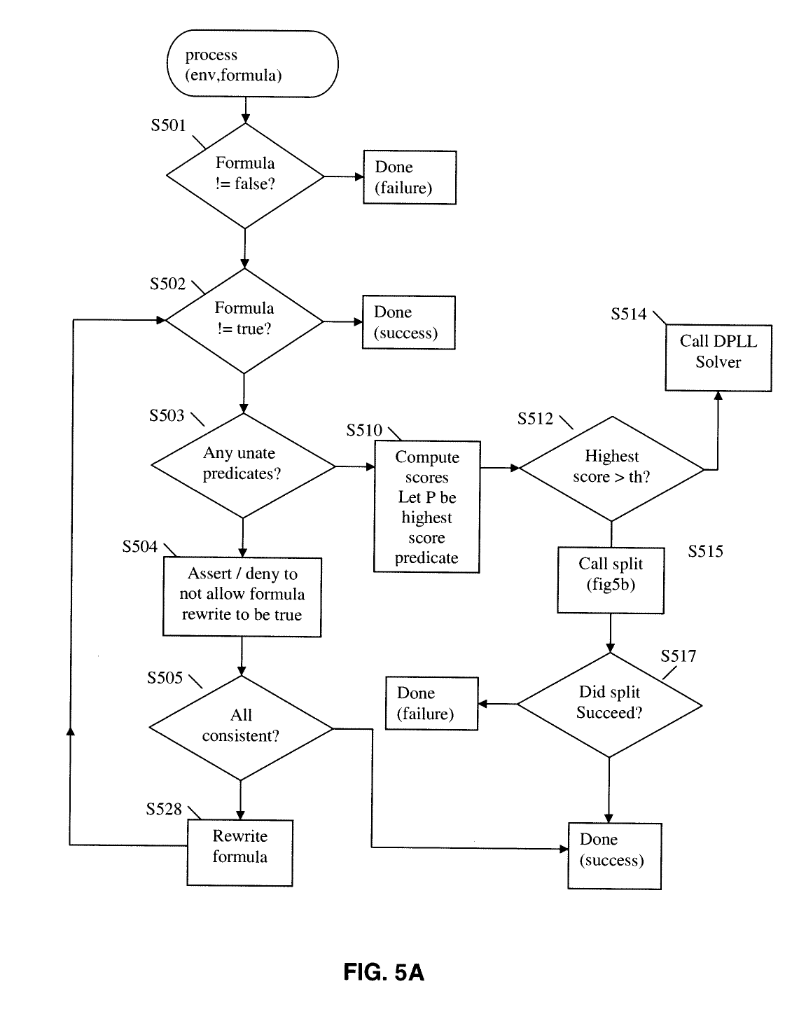

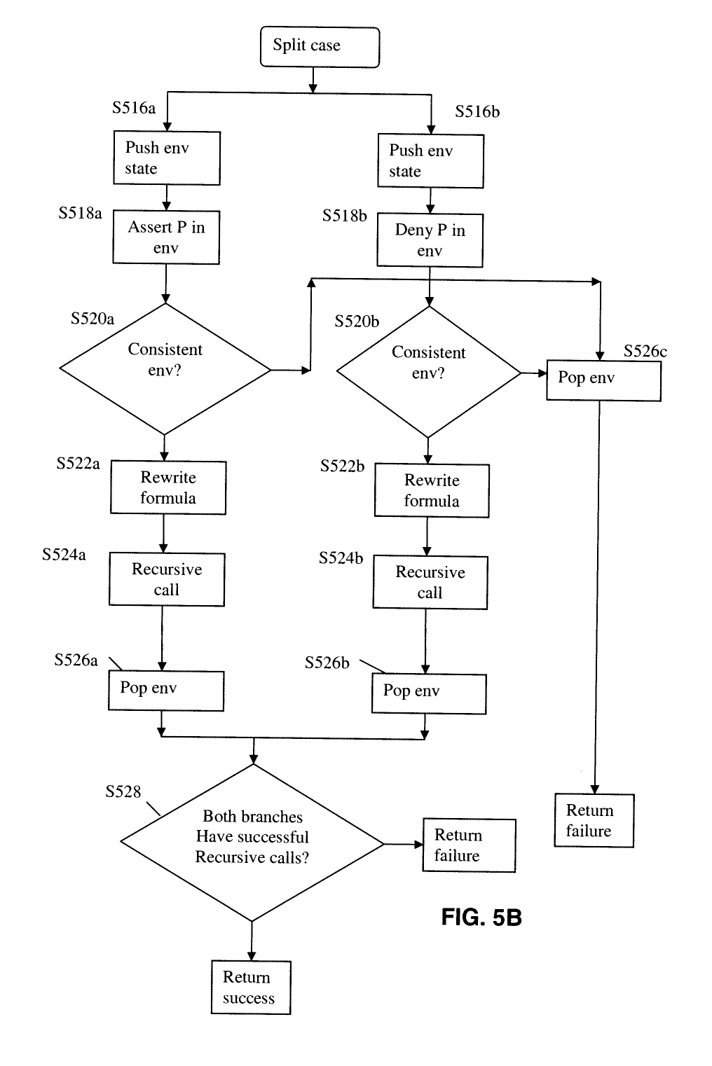

A flowchart illustrating an example operation of prover 100 is shown in FIGS. 5A and 5B. In this example, certain initialization of data structures and the like, such as processing performed by parser 102, is assumed. In general, the method involves a main routine recursively refining a formula and/or solving a formula using functionalities in pre-processor 104 and/or solver 108. The starting point in FIG. 5A can be considered as corresponding to each stage of the formula (i.e. the boxes) shown in FIG. 9.

As shown in the example of FIG. 5A, a first step S501 initially determines whether the formula has reduced to, or has been found by the DPLL solver to be false. If so, no further action needs to be taken as the branch (and the entire theorem) is invalid. Otherwise, beginning in step S502 it is recursively determined whether the formula has reduced to or has been found by the DPLL solver to be true. If this is the last branch and it is true, processing is done and the theorem has been proven. Otherwise, processing continues to refine and/or solve this or additional branches until the formula is fully solved.

In this example shown in FIG. 5A step S503, the set of all atomic predicates in the current formula are identified, and the unate detection algorithm such as module 202 is called to produce a set u (a subset of s)=the set of unate predicates in the formula. If u is not empty (as determined in step S503) then processing proceeds to step S504.

In step S504, each predicate in u whose denial allows formula to rewrite to true is asserted, and each predicate in u whose assertion allows formula to rewrite to true is denied. If all assertions and denials are consistent with the environment (determined in step S505, e.g. using modules 303, 304 and 305) then the formula is rewritten in step S528 (e.g. using rewriting module 204). If they are not consistent, then the branch is successful, and no rewriting is performed. Processing for this branch then ends. Otherwise, the formula is rewritten in step S528 and processing returns to S502.

Returning to the determination in step S503, if it was determined that there are no unate predicates in the formula, processing proceeds to step S510, where the score for each atomic predicate in s (e.g. add together the scores for assertion and denial) is computed (e.g. using scoring module 203).

If the predicate with the highest score is below some specified threshold (determined in step S512), then the DPLL(T) solver is called to finish this branch (step S514). The threshold score can be determined heuristically, for example, based on scores provided by the scoring module and/or the performance of DPLL(T) solver.

Otherwise, assume p is the predicate with the highest score. Now, processing in FIG. 5B is performed which splits the theorem into two cases, one with p asserted and the other with p denied. A recursive call to the process in FIG. 5A is made from the split process in FIG. 5B as needed to handle successive case splits from each of the two cases (e.g. successively moving down the branch with refined versions of the formula via case splits as shown in FIG. 9).

As shown in FIG. 5B, the “asserted” branch or path includes steps 518a, 520a, 522a and 524a and the “denied” branch or path includes 516b, 518b, 520b, 522b and 524b. Processing for the two paths can be concurrently or sequentially performed. Depending on the path (and after pushing the environment state), p is either asserted or denied in the environment (steps S518a and S518b). If the assertion/denial of p is not consistent with the environment (determined in step S520a or S520b), then restore the environment (step S526c), and end processing. Otherwise, rewrite the formula accordingly in step S522a or S522b and call the process in FIG. 5A with the rewritten formula (steps S524a and S524b). After restoring the environment in steps S526a, S526b, in step S528 it is determined whether the process has been repeated recursively until all branches have returned true. Depending on the results from all recursively split branches, processing from FIG. 5B returns either a success or failure indication, and control returns to S516 in FIG. 5A.

FIG. 6 illustrates an alternative embodiment of a theorem prover according to the invention. As shown in FIG. 6, heuristic theorem solver or prover 600 further includes encoder 606. Encoder 606 can include a small predicate set encoder and/or a difference logic encoder, as will be explained in more detail below.

This alternative embodiment recognizes that theorem provers are generally much more efficient on Boolean equations than predicates. The present invention further recognizes that various Boolean encoding algorithms exist which can abstract some equalities and inequalities in an expression with boolean variables. Consider the equation “a<b+1 or b<a”. One could replace the predicate “a<b+1” with the Boolean variable “A” and the predicate b<a with the Boolean variable “B”. The conjunction “not(A) and not(B)” represents the one possible combination or truth assignments that corresponds to a contradiction between the two predicates. Using this conjunct, one can construct the Boolean equation “A or B or (not(A) and not(B)) which is always true just as the original equation is always true. Accordingly, encoder 606 replaces one or more predicates in the original input theorem with Boolean variables and appropriate conjuncts so that it can be more efficiently solved.

One preferred Boolean encoding algorithm within encoder 606 is a small predicate set encoder algorithm. This algorithm determines if a theorem contains a small number of atomic predicates or small subset of atomic predicates which share no free variables with any other predicates (or a subset that forms a biconnected component in the case of difference logic). If so, then the encoder 606 abstracts these predicates to Boolean variables and “or”s them with conjuncts so as to represent all the disallowed truth assignments combinations. The disallowed truth assignment combinations are generated by testing all possible combinations of assertions and denials of the predicates. For example, the theorem (or portion of a theorem) having predicates (a<b and b<c) or c<a is encoded by small predicate set encoder as (P1 and P2) or P3 or (P1 and P2 and P3).

Another preferred Boolean encoding algorithm within encoder 606 is a difference logic encoder. One example implementation of such an encoder that can be included in encoder 606 will now be described in more detail.

For an equation containing a large number of atomic predicates using difference logic, the present invention provides an algorithm based on the idea of finding cycles in a graph formed from the inequalities. The algorithm builds upon work from the following paper: Ofer Strichman and S. Seshia and R. Bryant, Deciding separation formulas with SAT, Proc. of Computer Aided Verification, 2002

A difference logic theorem is a formula, φ, containing equations or predicates of the form vᵢ+c<vⱼ or vᵢ+c=vⱼ connected together with boolean connectives. Rather than reducing each equality to two inequalities, the difference logic encoder algorithm works directly with the equalities so as to reduce the number of Boolean variables introduced in the resulting expression.

First, from the set of difference logic equations, a constraint graph G(V,E) is created. The formalism is slightly different from that presented by Strichman. The graph is undirected. The vertices V are the free variables (e.g. vᵢ, vⱼ, etc.) from the difference logic equations in φ. Each edge e corresponds to the atomic predicates of φ involving the two vertices of the edge (e.g. there is an edge between vertices vᵢ and vⱼ corresponding to a predicate vᵢ+c<vⱼ). For any two vertices vᵢ and vⱼ, there is only one edge.

In the foregoing discussion, a term in the form b_{x<y} represents the boolean variable used to encode the inequality x<y. The term b_{y<=x} is also used interchangeably with not(b_{x<y}). The term B refers to the boolean formula resulting from encoding the difference logic formula φ.

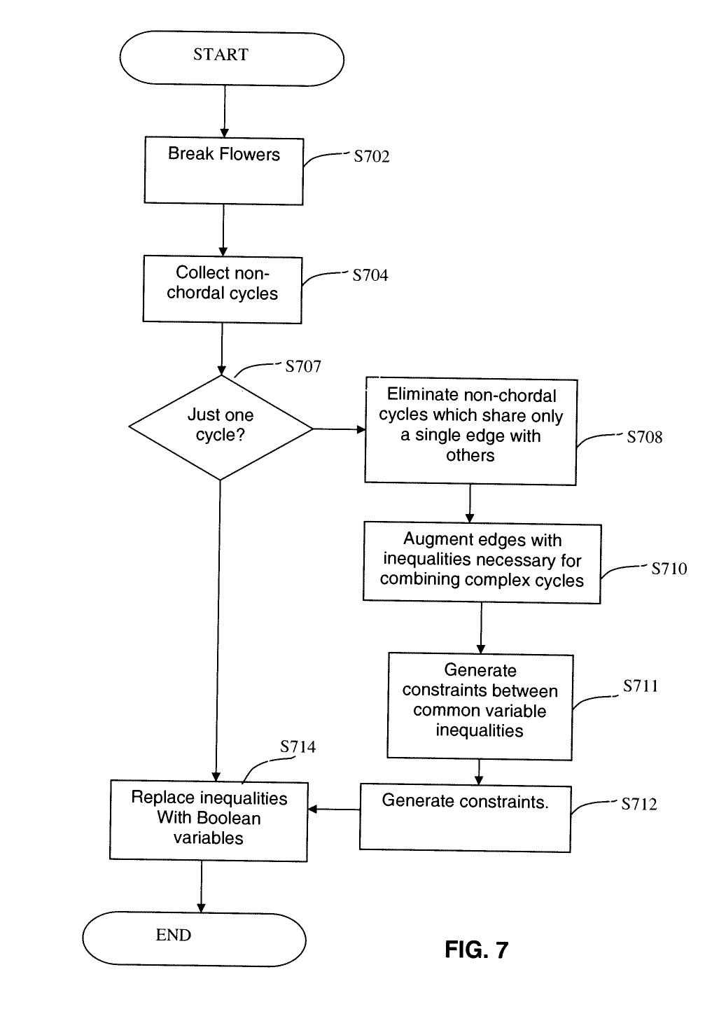

FIG. 7 is a flowchart illustrating one example implementation of a difference logic encoder according to the invention.

As shown in FIG. 7, a first step S702 includes breaking of flowers. Predicates are divided into several subsets. Each subset corresponds to a biconnected component, as that term is known in graph theory. More particularly, in the constraint graph formed with variables of a formula being the vertices and each predicate (which must contain two variables) forming an edge, a biconnected component is a subgraph of the graph in which there are two distinct paths between every pair of vertices and only one path to any vertex not in the component. Sometimes, one or more of these biconnected components share a single common variable (called a “flower variable”). Renaming of the flower variable in each biconnected component is done so that each has a different name of the “flower” variable.

As shown in FIG. 7, a next step S704 includes collecting non-chordal cycles. The algorithm first collects all the cycles involving three vertices. This is done by checking all pairs of edges e₁, and e₂ which connect vertices vᵢ and vⱼ and vertices vᵢ and vₖ respectively. If there is an edge between vⱼ and vₖ, then the set {vᵢ, vⱼ, vₖ} is identified as a no-chordal cycle. Non-chordal cycles with more than three vertices are then found using a depth first search. Note that for purposes of this algorithm, the concept of a non-chordal cycle is generalized. For any sequence of vertices in the cycle {v₁, . . . , vₙ}, If there is another path from v₁ to vₙ with fewer than n vertices, then this path is considered a chord.

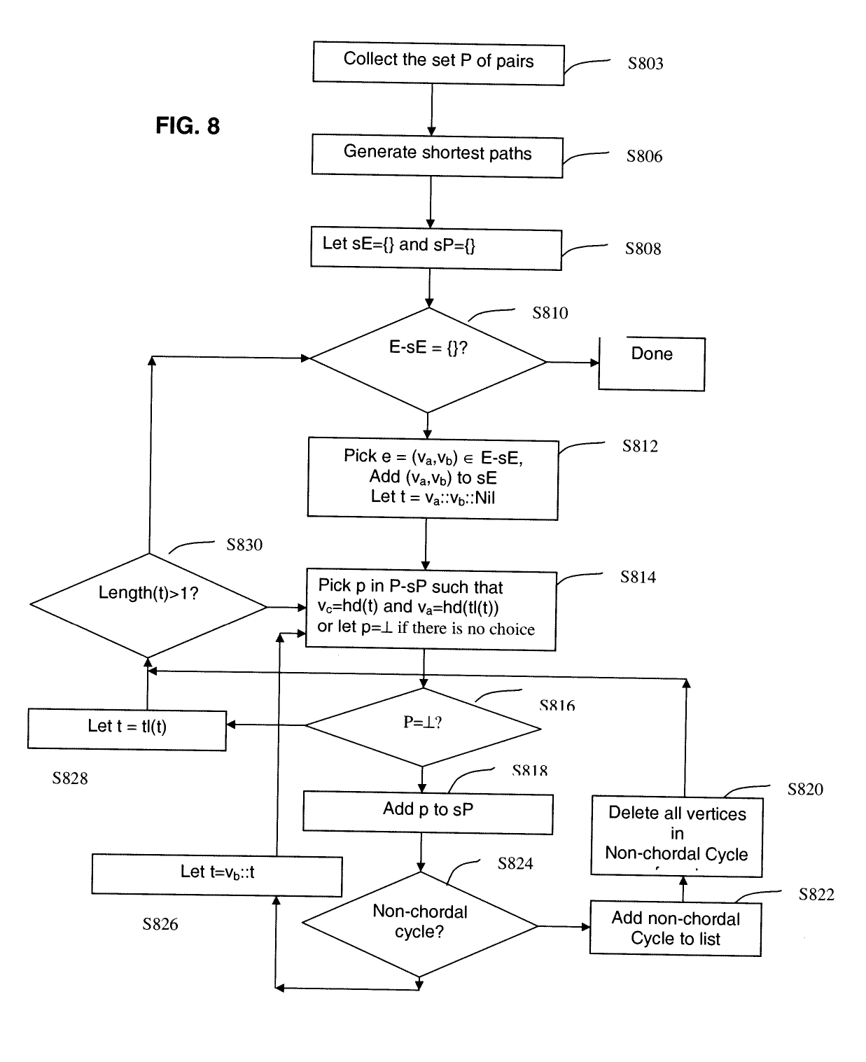

The depth first algorithm works through the following steps as shown in FIG. 8.

First in step S803 a set P is created which is a set of pairs of (e₁,e₂). Each pair is a pair of edges that share a common vertex as in the previous step. However, only the pairs that did not form three vertex cycles in the step above are collected. For each pair (e₁,e₂) in the set, the dual, (e₂,e₁), is also added.

Next in step S806, a shortest path algorithm is used to collect the shortest path between pairs of vertices (with the weight of each edge being one). For any two vertices v₁ and v₂, let p(v₁,v₂) represent a sequence of vertices being the path from v₁ to v₂. Let d(v₁,v₂) be the length (in vertices and counting only one of the two end vertices) of the path.

As shown in FIG. 8, processing enters a loop that uses the above data structures to enumerate all the non-chordal cycles with four or more vertices.

As shown in step S808, the process initializes two sets to being empty—the first set sE ⊂ E and sP ⊂ P. Remember that E is the set of edges from the graph G(V,E) from above.

As shown in FIG. 8, step S810 checks whether E-sE is empty. If it is, then processing is done.

As shown in FIG. 8, step S812 picks one edge e from E-sE. and sets t=vₐ::v_{b}::nil, wherein t is a list of vertices. Step S812 also adds e to sE.

As shown in FIG. 8, in step S814, a pair of edges p∈ P-sP is picked where p=(e₁,e₂). For purposes of this discussion v_{c} will be the common vertex of the two edges. vₐ will be the non-common vertex on e₁ and v_{b} will be the non-common vertex on edge e₂. If a pair p can be found such that hd(t)=v_{c}, and hd(tl(t))=vₐ (where hd is a function that returns the first element in the list and tl is a function that returns a new list that has everything except for the first element) then processing continues on to step S818. Otherwise, processing branches to step S828.

In step S828, the first element in the list is removed from t. Step S830 checks whether t still has at least two elements remaining. If it does, then processing returns to S814. If not, processing returns to step S810 and a new starting edge is chosen.

In step S824, processing determines whether v_{b} appended with some prefix of t forms a non-chordal cycle. Call this prefix v₁ . . . vₙ. This determination is done by checking the distance of the shortest path from v_{b} to vₙ. If this distance is less than n, then there is a cycle. When checking for non-chordal cycles, processing starts by testing the prefix of t containing three elements. Then one element at a time is added to the prefix and the test is redone until all possible prefixes have been tested. Once a non-chordal cycle is found, there is no need to continue testing prefixes as any additional cycles found will have at least one chord. If the cycle is found, processing continues to step S822. Otherwise processing returns to step S826.

Step S826 adds v_{b} to the beginning of t and returns processing to step S814.

Step S822 adds the non-chordal cycle to the set of non-chordal cycles. It then deletes the prefix of vertices v₁ . . . vₙ from t and goes back to step S830.

Returning to FIG. 7, step S708 involves eliminating non-chordal cycles where only one edge is shared with other non-chordal cycles. In this step, processing first looks for a cycle where only one edge connected by v₁ and vₙ and then processing uses the two rules described below for step S710 to add all possible accumulation inequalities involving v₁ and vₙ using this cycle. Next, all the other vertices and edges of the cycle are eliminated from the graph G(V,E). Finally, this elimination step is repeated until there are no more non-chordal cycles sharing just a single edge with others.

Finally, note that this elimination is only preserved for step S710. The work of step S708 is undone when processing goes to step S711.

As shown in FIG. 7, a next step S710 includes augmenting edges with accumulation inequalities necessary for combining complex cycles. The purpose of augmentation is to ensure that any contradiction in a set of inequalities arising from a non-chordal cycle will imply at east one contradiction in a set of inequalities from a chordal cycle. Consider the following set of inequalities, a<b, b<c, a−2<c, c<d and d<a If one only considers the positive, non-chordal cycles, the following two conjuncts are created “b_{a<b} and b_{b<c} and b_{a<c+2}” and “b_{d<=c} and b_{d<a} and not(b_{a<c+2})”. Note that bₑ is used to encode the equation e. In this example, there is a third cycle (which has a chord) represented by the conjunct b_{a<b} and b_{b<c} and b_{c<d} and b_{d<a}. The first two conjuncts do not imply the third. However, if the inequality a<c (which is formed by combining a<b and b<c) is added, when one generates constraints based on non-chordal cycles, in addition to the above, the following two chordal conjuncts, “b_{a<b} and b_{b<c} and b_{a<c}” and “b_{c<d} and b_{d<a} and b_{a<c}”. These new chordal conjuncts imply the one non-chordal conjunct.

The general rule for creating these inequalities is the following. Given a set of variables v₁ . . . vₙ which form the non-chordal cycle, and a set of inequalities v₁+c₁ propto₁ v₂ . . . vₙ₋₁+cₙ₋₁∝ₙ₋₁vₙ where each ∝ᵢ is either =, < or <=, and that there exists some atomic predicate relating v₁ and vₙ, then produce either the edge v₁+c<vₙ if there is at least one ∝ᵢ which is < or v₁+c<=vₙ otherwise. Note that c=c₁+ . . . +cₙ. Also note that for purposes of creating the inequality sequence above, the negation of an atomic predicate a+c<b, the equation b−c<=a can be used.

There is a second rule to cover the corner case where a set of inequalities implies an equality. This happens for example with the three inequalities a<=b, b<=c and c<=a. If all three of these are true then it implies that a=b, b=c and c=a. More formally, for all non-chordal cycles v₁ . . . vₙ, where there is a set of inequalities of the form v₁+c₁ propto₁ v₂ . . . vₙ+cₙ∝ₙv₁ where each propto₁ is either = or <=, if c₁+ . . . +cₙ=0 then add the equality vᵢ+cᵢ=v_{(i+1)mod n} for each i where proptoᵢ is <=.

For both of these equation generation rules, the equation is only added if the two variables in that equation form an edge which is not only in the cycle used to generate the equation but also in another non-chordal cycle.

The two rules above are applied exhaustively until no further inequalities can be added.

As shown in FIG. 7, a next step S711 includes generating constraints between common variable inequalities. Within each edge, constraints are preferably generated for each contradictory set of equations (or their negation). Generally, these constraints are pairs. There is one special case and that is if the three equations vᵢ+c<vⱼ, vⱼ−c<vᵢ and vᵢ+c=vⱼ are in the set. The ternary constraint that all three cannot be false must be added.

As shown in FIG. 7, a final step S712 includes generating constraints. Once all the necessary inequalities have been added, the next step is to generate constraints. The constraint generation rule is that for any non-chordal cycle v₁ . . . vₙ and a set of equations v₁+c₁∝₁v₂ . . . vₙ+cₙ∝v₁ where each ∝ᵢ is either =, < or <= and such that c₁+ . . . +cₙ>0 (or where c₁+ . . . cₙ=0 there is at least one equation with a <) we add the conjunct “b_{v(1)+c(1)∝(1)v(2)} and . . . and b_{v(n))+c(n)∝(n)v(1)}”. Note the following special case. Consider the three inequalities a<b, b<c and c<=a. Two conjuncts will be generated. “b_{a<b} and b_{b<c} and b_{c<=a}” and “b_{b<=a} and b_{c<=b} and b_{a<c}. There is one additional special case. If the set of inequalities implies equalities, the encoder should add conjuncts to represent these implications. Formally, for any non-chordal cycle v₁ . . . vₙ where there is a set of inequalities v₁+c₁∝₁v₂ . . . vₙ+cₙ ∝ₙv₁ where each ∝ᵢ is either = or <=, then preferably add the conjunct b_{v(1)+c(1)∝(i)v(2)} and . . . and b_{v(n)+c(n)∝(n)v(1)} and b_{v(i)+c(i)=v(i+1)mod n} for each i where ∝ᵢ is <=.

Finally in step S714, each difference logic constraint u+c∝v is replaced with a Boolean variable b_{u+c∝v}.

It should be noted that a number of alternatives to the above embodiment are possible. A first alternative involves incorporation of unate term information

A unate predicate is one which when either asserted or denied makes the entire formula φ false. An algorithm for detecting unate predicates is given above. If a predicate b is unate in that when denied, it makes φ true, then any conjunct with “b and B” can be reduced to “B”. If the predicate b is unate in that when asserted, it makes φ true, then any conjunct that contains b can be removed.

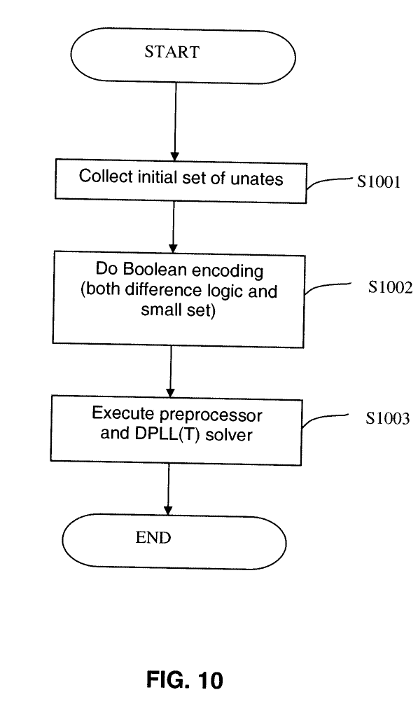

FIG. 10 is a flowchart illustrating an example operation of prover 600 for this embodiment of the invention. As shown in FIG. 10, an initial step S1001 includes collecting an initial set of unates in the original theorem. This step can include the processing described above in connection with FIG. 4. Next, in step S1002, encoder 606 is called to perform the predicate set and/or difference logic encoding processing described above, preferably using the unate term information as mentioned above, to replace as many predicates in the theorem with Boolean variables. Next, the preprocessor 104 and solver 108 are run, for example using the processing described above, on the revised theorem.

Note that the unate information can be used to restrict the number of constraints generated in step S712. If P is a predicate that when asserted makes a theorem true, then any constraint generated in S712 in which P is positive can be eliminated. Similarly, if P is a predicate that when denied makes our theorem true, then any constraint generated in S712 in which P is negative can be eliminated.

A second possible alternative to the algorithm described in FIG. 7 involves incorporation of range limit information

An important observation is that many useful difference logic problems assign specific ranges to the variables. Often it is the case that the accumulation inequality generation algorithm above will create inequalities with larger and larger constants c. Once these constants go beyond the range of the variables one need not continue generating the inequalities.

The first step is to detect range information. Often, range information is encoded as unate inequalities of the form “v−u<=r” and “v−l>=r” where “u” is the upper bound, “l” is the lower bound and “r” is a reference variable. for each set of inequalities corresponding to a bi-connected component in the inequality graph, a reference variable “r” is identified. A variable “r” is defined to be a reference variable for a bi-connected component, if it is used in unate inequalities of the form above for defining upper and lower bounds for all other variables in the bi-connected component. Once “r” is found, then the upper and lower bounds for the other variables are extracted. We shall use u(v) and l(v) to represent the upper and lower bounds of the variables.

As an example of the above, consider the formula not(a−1<=cvclZero) or not(a−0>=cvclZero) or not(b−2<=cvclZero) or not (b−0>=cvclZero). “cvclZero” is the reference variable. “a” is between cvclZero and cvclZero+1. B is between cvclZero and cvclZero+2.

A next step in this alternative embodiment involves restricting inequality and conjunct generation

If for any inequality “vᵢ+c∝ᵢvᵢ₊₁”, the range information is sufficient to ensure that it is either true or false, then we do not need to add it in the augmentation step above. In addition to restricting edge generation, we also need to generate conjuncts that restrict partial cycles. Formally, for a non-chordal cycle v₁ . . . vₙ, if we have the equations v₁+c₁∝₁v₂ . . . vₘ₋₁+cₘ₋₁∝ₘ₋₁vₘ where m<n, each ∝ᵢ is either =, < or <= and such that “u(vₘ)−l(v₁)<c₁+ . . . +cₘ” then we add the conjunct “b_{v(1)+c(1)∝(1)v(2)} and . . . and b_{v(m-1)+c(m-1)∝(m-1) v(m)}”.

Additional embodiments and implementations of the invention are possible, including further tuning of HTP algorithms, extension of algorithms to handle quantifiers and set theory (e.g. QBFresearch); Extensions of algorithms to handle recursive data types; Applications of HTP to constraint solving problems; and Application of HTP to software and hardware verification problems.

Moreover, the above embodiments may be altered in many ways without departing from the scope of the invention. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

What is claimed is:

1. A method comprising:
pre-processing a theorem before it is provided to a SAT solver; and
operating on the pre-processed theorem using the SAT solver.

2. A method according to claim 1, wherein the pre-processing step includes detecting a set of one or more unate predicates in the theorem.

3. A method according to claim 2, wherein the detecting step includes constructing one or more of assert_makes_true, deny_makes_true, assert_makes_false and deny_makes_false sets of predicates.

4. A method according to claim 2, wherein the pre-processing step further includes choosing a case split based on the detected set.

5. A method according to claim 1, wherein the pre-processing step includes generating a score related to the amount of rewriting of the theorem resulting from asserting or denying a predicate in the theorem.

6. A method according to claim 5, wherein the pre-processing step further includes choosing case splits based on the score.

7. A method according to claim 1, wherein the pre-processing step includes determining a score based on a predicted number of inferences done in a domain theory.

8. A method according to claim 1, wherein the pre-processing step includes rewriting to simplify the theorem.

9. A method according to claim 1, further comprising:
encoding difference logic; and
replacing terms in the theorem based on the encoding.

10. A method according to claim 9, wherein the replacing step includes replacing inequalities with Boolean expressions.

11. A method according to claim 9, further comprising:
generating accumulation inequalities based upon non-chordal cycles in a graph.

12. A method according to claim 9, wherein the step of encoding difference logic uses range information to restrict the number of accumulation inequalities generated.

13. A method according to claim 12, wherein the step of encoding difference logic employs a unate predicate detector to help find the ranges of inequalities.

14. A method according to claim 1, further comprising:
detecting small sets of predicates in the theorem; and
replacing terms in the theorem based on the detection.

15. A method according to claim 14, wherein the replacing step includes replacing predicates with Boolean expressions.

16. A method for recursively solving a theorem comprising:
receiving a theorem;
identifying a predicate to assert or deny in the theorem;
rewriting the theorem based on the assertion or denial;
determining whether to assert or deny any other predicates in the rewritten theorem; and
solving the rewritten theorem with a SAT solver if the determining step indicates no other predicates for assertion or denial.

17. A method according to claim 16, wherein the identifying step includes detecting a unate split in the theorem.

18. A method according to claim 16, wherein the identifying step includes generating a score related to the amount of rewriting of the theorem resulting from asserting or denying a predicate in the theorem.

19. A method according to claim 16, further comprising:
replacing terms in the theorem based on an encoding algorithm before the identifying step.

20. A method according to claim 19, wherein the encoding algorithm includes identifying difference logic terms in the theorem and the replacing step includes replacing identified difference logic terms with Boolean expressions.
